(19) United States
(12) Patent Application Publication
(10) Pub. No.: US 2026/0252748 A1
(43) Pub. Date: Aug. 27, 2026

(54) MORTAR LINING WALL THICKNESS DESIGN METHOD AND DEVICE, AND PIPE REPAIRING METHOD AND DEVICE

(71) Applicant: CHINA THREE GORGES CORPORATION, Wuhan, Hubei (CN)

(72) Inventors: Shun DONG, Wuhan, Hubei (CN); Erqing HUI, Wuhan, Hubei (CN); Han ZHANG, Wuhan, Hubei (CN)

(73) Assignee: CHINA THREE GORGES CORPORATION, Wuhan, Hubei (CN)

(21) Appl. No.: 18/714,091

(22) PCT Filed: Jun. 15, 2023
(86) PCT No.: PCT/CN2023/100475

§ 371 Date: May 29, 2024

(30) Foreign Application Priority Data
Aug. 10, 2022 (CN) 202210953851.2

(51) Int. Cl. G06F 30/13

(52) U.S. Cl. CPC G06F 30/13

(57) ABSTRACT

A mortar lining wall thickness design method and device, and a pipe repairing method and device are provided. The mortar lining wall thickness design method includes the following steps: respectively determining a pipe top vertical deformation of an existing pipe reaching a repaired design service life and an equivalent additional load needed to be applied to the existing pipe reaching the pipe top vertical deformation based on defect data of the existing pipe; determining section and interfacial stress state parameters of the repaired existing pipe based on the equivalent additional load and a mortar lining wall thickness assumed value; and comparing a stress state parameter with a standard strength parameter, and determining whether the mortar lining wall thickness assumed value is taken as a mortar lining target wall thickness value according to a comparative result.

### TECHNICAL FIELD

The present invention relates to the field of trenchless pipe updating and repairing and particularly relates to a mortar lining wall thickness design method and device, and a pipe repairing method and device applicable to pipe spray repairing.

### BACKGROUND

A mortar spraying method is a common trenchless pipe repair technology. Thanks to its advantages of high flexibility, and no limitation on pipe structures, shapes, and specifications, the mortar spraying method is gradually applied to repairing drain lines, box culverts, and inspection wells. The method can spray cement mortar to an inner wall of an existing pipe by way of manual spraying, centrifugal spraying, high-pressure gas rotary jet grouting, and the like, to further form a mortar lining. When the mortar spraying method is used to repair the existing pipe, a wall thickness design is the key to a lining structure design.

The mortar lining wall thickness is predicted by taking a Timoshenko free ring buckling model as a theoretical basis. However, the model is only applicable to flexible linings (including lining pipes such as CIPP and PE) and is hardly applicable to linings formed by fragile materials such as mortar. Therefore, there is an urgent need for a lining wall thickness design method applicable to mortar spray repairing.

### SUMMARY

Therefore, to overcome the deficiency that the prior art is hardly applicable to mortar spray repairing, the present invention provides a mortar lining wall thickness design method, and a pipe repairing method and device.

According to a first aspect, the present invention provides a mortar lining wall thickness design method, including: determining a first equivalent elasticity modulus of an existing pipe in a current state and a second equivalent elasticity modulus of the existing pipe reaching a repaired design service life based on defect data of the existing pipe; determining a pipe top vertical deformation of the existing pipe reaching the repaired design service life based on a pipe top linear load on a unit length of the existing pipe and the second equivalent elasticity modulus; determining an equivalent additional load needed to be applied to the existing pipe reaching the pipe top vertical deformation in the current state according to the first equivalent elasticity modulus, the second equivalent elasticity modulus, and the pipe top linear load; determining a stress state parameter of the existing pipe repaired according to a mortar lining wall thickness assumed value based on the equivalent additional load and the mortar lining wall thickness assumed value; and comparing a stress state parameter with a standard strength parameter, and determining whether the mortar lining wall thickness assumed value is taken as a mortar lining target wall thickness value according to a comparative result.

The design method characterizes an objective fact that a deformation-resisting capability of the existing pipe is continuously degenerated with the increase of pipe age by using the additional equivalent load. Based on cracking damage of the mortar lining under the action of the additional load as a lining wall thickness design ground and slip failure of a mortar lining-existing pipe interface as a lining wall thickness checking ground, the method further guarantees that the repaired existing pipe is capable to resist an external load, thereby reducing the risk that the existing pipe is secondarily damaged.

According to a second aspect, the present invention further provides a pipe repairing method, including: acquiring a mortar lining target wall thickness value when mortar is sprayed to repair an existing pipe, where the mortar lining target wall thickness value is determined by the mortar lining wall thickness design method in any one of the first aspect and optional implementations thereof. The mortar is sprayed to repair the existing pipe according to the mortar lining target wall thickness value.

In the method, the spraying mortar to repair the existing pipe according to the mortar lining target wall thickness value is capable to effectively reducing the mortar lining wall thickness on the premise of ensuring that the structural strength of the repaired pipe meets a requirement, thereby further lowering the costs of engineering materials.

According to a third aspect, the present invention further provides a mortar lining wall thickness design device, including:
a first determination unit, configured to determine a first equivalent elasticity modulus of an existing pipe in a current state and a second equivalent elasticity modulus of the existing pipe reaching a repaired design service life based on defect data of the existing pipe;
a second determination unit, configured to determine a pipe top vertical deformation of the existing pipe reaching the repaired design service life based on a pipe top linear load on a unit length and the second equivalent elasticity modulus of the existing pipe;
a third determination unit, configured to determine an equivalent additional load needed to be applied to the existing pipe reaching the pipe top vertical deformation in the current state according to the first equivalent elasticity modulus, the second equivalent elasticity modulus, and the pipe top linear load;
a fourth determination unit, configured to determine a stress state parameter of the existing pipe repaired according to a mortar lining wall thickness assumed value based on the equivalent additional load and the mortar lining wall thickness assumed value of the mortar lining wall thickness; and
a determining unit, configured to compare the stress state parameter with a standard strength parameter, and to determine whether the mortar lining wall thickness assumed value is taken as a mortar lining target wall thickness value according to a comparative result.

According to a fourth aspect, the present invention further provides a pipe repairing device, including:
an acquisition unit, configured to acquire a mortar lining target wall thickness value when mortar is sprayed to repair an existing pipe, wherein the mortar lining target wall thickness value is determined by the mortar lining wall thickness design method in any one of the first aspect and optional implementations thereof; and
a repairing unit, configured to spray mortar to repair the existing pipe according to the mortar lining target wall thickness value.

According to a fifth aspect, an implementation of the present invention further provides a computer device, including a memory and a processor, where the memory and the processor are in communication connection with each other, the memory stores a computer instruction, and the processor executes the computer instruction to execute the mortar lining wall thickness design method in any one of the first aspect and optional implementations thereof or the pipe repairing method in the second aspect.

According to a sixth aspect, an implementation of the present invention further provides a computer-readable storage medium, storing a computer instruction, where the computer instruction is used to make a computer perform the mortar lining wall thickness design method in any one of the first aspect and optional implementations thereof or the pipe repairing method in the second aspect.

### BRIEF DESCRIPTION OF THE DRAWINGS

FIG. 1 is a flowchart of a mortar lining wall thickness design method provided in an exemplary embodiment.

FIG. 2 is a schematic diagram of a section of a pipe provided in an exemplary embodiment.

FIG. 3 is a flowchart of another mortar lining wall thickness design method provided in an exemplary embodiment.

FIG. 4 is a flowchart of yet another mortar lining wall thickness design method provided in an exemplary embodiment.

FIG. 5 is a flowchart of yet another mortar lining wall thickness design method provided in an exemplary embodiment.

FIG. 6 is a flowchart of yet another pipe repairing method provided in an exemplary embodiment.

FIG. 7 is a structural block diagram of a mortar lining wall thickness design method provided in an exemplary embodiment.

FIG. 8 is a structural block diagram of a pipe repairing device provided in an exemplary embodiment.

FIG. 9 is a schematic diagram of a hardware structure of a computer device provided in an exemplary embodiment.

### DETAILED DESCRIPTION OF THE EMBODIMENTS

The technical solution of the present invention will be clearly and intactly described below in combination with drawings.

A mortar lining wall thickness is designed by taking a Timoshenko free ring buckling model as a theoretical basis. However, the model is only applicable to flexible linings and is hardly applicable to linings formed by fragile materials such as mortar. In addition, when the lining wall thickness is designed in the related art, the influence caused by degeneration as a result of the increase of flexural rigidity of the existing pipe with the pipe age and interfacial slip failure between the mortar lining and the existing pipe is not considered, which is inconsistent with the actual loaded condition and the failure mode of the mortar lining, so that the effectiveness of repairing the existing pipe is affected.

To solve the above problem, the embodiment of the present invention provides a mortar lining wall thickness design method for a computer device. It is to be noted that an executing main body thereof is the mortar lining wall thickness design device which can be implemented as a part or all of the computer device by means of software, hardware, or combination of software and hardware. The computer device can be a terminal or a client or a server. The server can be one server or a server cluster formed by a plurality of servers. The terminal in the embodiment of the present invention can be an intelligent hardware device such as a smart phone, a personal computer, a tablet computer, a wearable device, and an intelligent robot. In the method embodiment below, it is described by taking the executing main body as the computer device.

The computer device in the embodiment is applied to an application scenario of the lining wall thickness design when the mortar is sprayed to the existing pipe to repair the existing pipe. The mortar lining wall thickness design method provided according to the present invention, the equivalent elasticity modulus of the existing pipeline in the current state and the equivalent elasticity modulus thereof reaching the repaired design service life. The pipe top vertical deformation of the existing pipe reaching the repaired design service life is predicted based on the pipe top linear load on the unit length of the existing pipe and the second equivalent elasticity modulus, so that the equivalent additional load needed to be applied to the existing pipe reaching the pipe top vertical deformation is predicted. To improve the reasonability of the mortar lining wall thickness and avoid ineffective repair of the existing pipe, the stress state parameter of the existing pipe repaired is determined according to the mortar lining wall thickness assumed value based on the mortar lining wall thickness assumed value. According to the comparison result between the stress state parameter and the standard strength parameter, the reasonability of the mortar lining wall thickness assumed value is verified, so that it is guaranteed that the repaired existing pipe is capable to effectively resisting an external load, thereby reducing the risk that the existing pipe is being secondarily damaged.

For the convenience of distinguishment, the equivalent elasticity modulus of the existing pipe in the current state is expressed by the first equivalent elasticity modulus, and the equivalent elasticity modulus of the existing pipe reaching the repaired design service life based on defect data of the existing pipe is expressed by the second equivalent elasticity modulus.

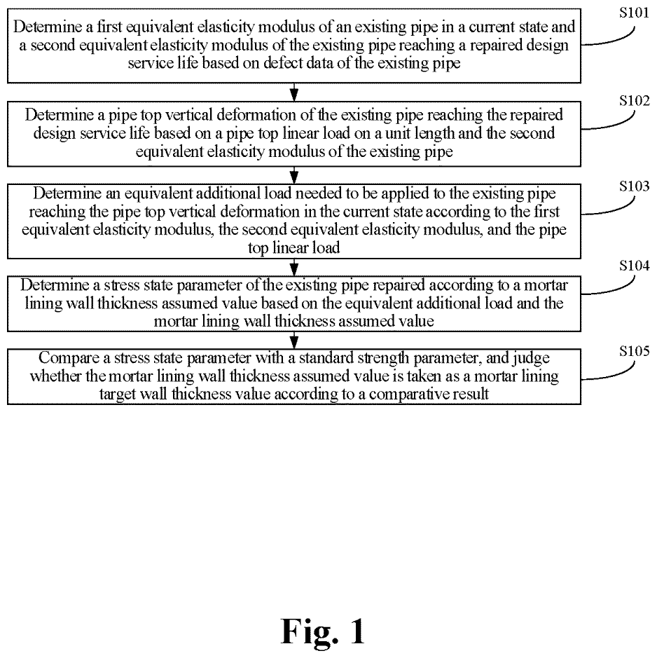

FIG. 1 is a flowchart of a mortar lining wall thickness design method provided in an exemplary embodiment. As shown in FIG. 1, the mortar lining wall thickness design method includes the following steps S101-S105.

In step S101, the first equivalent elasticity modulus of an existing pipe in a current state and a second equivalent elasticity modulus of the existing pipe reaching a repaired design service life are determined based on defect data of the existing pipe.

In the embodiment of the present invention, the using condition of the existing pipe in the current state can be determined through defect data of the existing pipe, so that in combination with the service life of the existing pipe, the first equivalent elasticity modulus of the existing pipe in the current state can be determined and the second equivalent elasticity modulus of the existing pipe reaching the repaired design service life can be predicted.

In step S102, a pipe top vertical deformation of the existing pipe reaching the repaired design service life is determined based on a pipe top linear load on a unit length of the existing pipe and the second equivalent elasticity modulus.

In the embodiment of the present invention, the stress condition of the existing pipe on the unit length in the current state can be determined through the pipe top linear load on the unit length of the existing pipe, so that the deformation condition of a pipe structure of the existing pipe in a service process is further determined. This is because the deformation condition of the pipe structure is related to the service life. Therefore, to determine the change of the pipe structure of the existing pipe reaching the repaired design service life, the pipe top vertical deformation of the existing pipe reaching the repaired design service life is determined based on the pipe top linear load on the unit length of the existing pipe and the second equivalent elasticity modulus.

In an actual scenario, the pipe top vertical deformation can be determined according to the following equation:

$$Δ = \frac{{q}_{soil} {D}^{4}}{192 {E}_{2} {I}_{2}} ,$$

where D represents a pipe outer diameter of the existing pipe; E₂ represents the second equivalent elasticity modulus; and I₂ represents the second equivalent section inertia moment of the existing pipe reaching the repaired design service life.

The product of the second equivalent elasticity modulus E₂ and the second equivalent section inertia moment I₂ of the existing pipe reaching the repaired design service life is the equivalent flexural rigidity of the existing pipe reaching the repaired design service life.

In an example, the pipe top linear load on the unit length of the existing pipe can be calculated based on Design Specifications on Pipe Structure of Water Supply and Sewerage Works, which is not described repeatedly herein.

In step S103, an equivalent additional load needed to be applied to the existing pipe reaching the pipe top vertical deformation in the current state is determined according to the first equivalent elasticity modulus, the second equivalent elasticity modulus, and the pipe top linear load.

In an example, if the equivalent section inertia moment of the existing pipe in the service process does not change, the equivalent additional load is determined by the following equation:

$$Δ {q}_{soil} = \frac{{E}_{1}}{{E}_{2}} \cdot {q}_{soil} ,$$

Δqₛₒᵢₗ is the equivalent additional load, E₁ is the first equivalent elasticity modulus, E₂ is the second equivalent elasticity modulus, and qₛₒᵢₗ is the pipe top linear load.

In an example, if the equivalent section inertia moment of the existing pipe in the service process changes with an increase of the service life, the first equivalent flexural rigidity of the existing pipe in the current state can be determined in combination with the first equivalent section inertia moment and the first equivalent elasticity modulus of the existing pipe in the current state. The second equivalent flexural rigidity of the existing pipe reaching the repaired design service life is determined in combination with the second equivalent section inertia moment of the existing pipe reaching the repaired design service life and the second equivalent elasticity modulus. Therefore, the equivalent additional load is determined by the following equation:

$$Δ {q}_{soil} = \frac{{E}_{1} {I}_{1}}{{E}_{2} {I}_{2}} \cdot {q}_{soil} ,$$

Δqₛₒᵢₗ is the equivalent additional load, E₁ is the first equivalent elasticity modulus, I₁ is the first equivalent section inertia moment, E₂ is the second equivalent elasticity modulus, I₂ is the second equivalent section inertia moment, and qₛₒᵢₗ is the pipe top linear load.

In Step S104, the stress state parameter of the existing pipe repaired is determined according to the mortar lining wall thickness assumed value based on the equivalent additional load and the mortar lining wall thickness assumed value.

In the embodiment of the present invention, the mortar lining wall thickness assumed value can be construed as a pre-estimated spray thickness of the existing pipe repaired by spraying mortar with a fragile repair material.

In step S105, the stress state parameter is compared with the standard strength parameter, and whether the mortar lining wall thickness assumed value is taken as a mortar lining target wall thickness value is determined according to a comparative result.

In the embodiment of the present invention, the standard strength parameter can be construed as the maximum bearable stress state parameter of the existing pipe after the existing pipe is repaired according to the mortar lining wall thickness assumed value. When the stress state parameter exceeds the standard strength parameter, the pipe structure of the existing pipe will be damaged, which further affects the structural stability of the existing pipe.

Therefore, to determine whether the mortar lining wall thickness assumed value is reasonable, the stress state parameter is compared with the standard strength parameter, and whether the mortar lining wall thickness assumed value is taken as the mortar lining target wall thickness value is determined according to the comparative result. The mortar lining target wall thickness value can be construed as the mortar lining target wall thickness value finally used to repair the existing pipe by spraying mortar.

In an embodiment, if the comparison result is that the stress state parameter is consistent with the standard strength parameter, it indicates that when the existing pipe is repaired with the mortar lining wall thickness assumed value, the repaired existing pipe has enough structural strength to resist the external load. Therefore, the mortar lining wall thickness assumed value can be taken as the mortar lining wall thickness target value.

If the comparison result is that the stress state parameter is inconsistent with the standard strength parameter, it indicates that when the existing pipe is repaired with the mortar lining wall thickness assumed value, the repaired existing pipe does not have enough structural strength to resist the external load. Therefore, to guarantee the structural stability of the existing pipe, the mortar lining wall thickness assumed value is re-determined to re-determine the stress state parameter based on the re-determined mortar lining wall thickness assumed value.

Through the above embodiment, the design method characterizes an objective fact that a deformation-resisting capability of the existing pipe is continuously degenerated with an increase of pipe age by using the additional equivalent load. Based on cracking damage of the mortar lining under the action of the additional load as a lining wall thickness design ground and slip failure of a mortar lining-existing pipe interface as a lining wall thickness checking ground, the method further guarantees that the repaired existing pipe is capable to resist the external load.

A specific process of determining the stress state parameter is described in the following embodiment.

In the embodiment, the pipe top section internal force of the repaired existing pipe under the action of the equivalent additional load can be determined based on the equivalent additional load, so that the stress state parameter of the existing pipe repaired is determined according to the mortar lining wall thickness assumed value based on the mortar lining wall thickness assumed value and the pipe top section internal force.

A pipe top sectional inner force can include a pipe top sectional bending moment and a pipe top sectional shearing force. The pipe top sectional bending moment can be determined by the following equation:

$$M = \frac{1}{16} \cdot Δ {q}_{soil} {D}^{2} ,$$

where M represents the pipe top section bending moment, Δqₛₒᵢₗ represents the equivalent additional load, and D represents a pipe outer diameter of the existing pipe.

The pipe top section shearing force can be determined by the following equation:

$${F}_{Q} = \frac{1}{2} \cdot Δ {q}_{soil} D ,$$

where F_{Q} represents the pipe top sectional sharing force, Δqₛₒᵢₗ represents the equivalent additional load, and D represents the pipe outer diameter of the existing pipe.

The stress state of the repaired existing pipe according to the mortar lining wall thickness assumed value includes: pipe top inner wall tensile stress, interfacial tensile stress between the existing pipe and the mortar lining, and interfacial shearing stress between the existing pipe and the mortar lining. The pipe top inner wall tensile stress is used to characterize a sectional stress state of the repaired existing pipe, and the interfacial tensile stress and the interfacial shearing stress are used to characterize an interfacial stress state between the existing pipe and the mortar lining.

After the existing pipe is repaired according to the mortar lining wall thickness assumed value, the pipe top inner wall tensile stress is determined by the following equation:

$${σ}_{s} = \frac{{ME}_{3}}{{E}_{1} {J}_{a} + {E}_{3} {J}_{b}} \cdot \frac{{Ry}^{′}}{R - {y}^{′}} - \frac{{ME}_{3}}{( {E}_{1} {A}_{a} + {E}_{3} {A}_{b} ) \cdot R} ,$$

$${J}_{a} = {R}^{3} b \cdot ln ( 1 + \frac{2 {t}_{1} ( 1 + β η )}{2 R - {t}_{1} + ( 2 R + {t}_{3} ) \cdot β η} ) + {Rbt}_{1} \cdot ( \frac{βη \cdot ( {t}_{1} + {t}_{3} )}{2 + 2 βη} - R ) ,$$

$${J}_{b} = {R}^{3} b \cdot ln ( 1 + \frac{2 {t}_{3} ( 1 + β η )}{2 R - {t}_{1} + ( 2 R - {t}_{3} ) βη - 2 {t}_{3}} ) - R b {t}_{3} \cdot ( \frac{1 + β}{2 + 2 β η} \cdot {t}_{1} + R ) ,$$

$$β = \frac{{t}_{3}}{{t}_{1}} , η = \frac{{E}_{3}}{{E}_{1}} ,$$

where σₛ is the pipe top inner wall tensile stress, and R is a radius of an equivalent neutral axis of the repaired existing pipe; y′ is a distance between the equivalent neutral axis of the repaired existing pipe and the inner wall of the mortar lining; E₁ is the first equivalent elasticity modulus; E₃ is the elasticity modulus of the mortar lining; t₁ is a first mean residual wall thickness of the existing pipe in the current state; Aₐ is a sectional area of the existing pipe within a unit length; and A_{b} is a sectional area of the mortar lining with the unit length. The attribute data of the existing pipe includes: a radius of an equivalent neutral axis of the repaired existing pipe, a distance between the equivalent neutral axis of the repaired existing pipe and the inner wall of the mortar lining, and a sectional area of the existing pipe within a unit length; and a sectional area of the mortar lining with the unit length.

After the existing pipe is repaired according to the mortar lining wall thickness assumed value, the interfacial tensile stress between the existing pipe and the mortar lining is determined by the following equation:

$${σ}_{r} = ( \frac{{ME}_{3}}{{E}_{1} {J}_{a} + {E}_{3} {J}_{b}} \cdot {K}_{b} - \frac{{ME}_{3}}{( {E}_{1} {A}_{a} + {E}_{3} {A}_{b} ) \cdot R} \cdot {A}_{b} ) \cdot \frac{1}{b \cdot ( R + {t}_{3} - {y}^{′} )} ,$$

$${K}_{b} = {R}^{2} b \cdot ln ( 1 + \frac{2 {T}_{3} ( 1 + β η )}{( 2 R - {t}_{3} ) \cdot ( 1 + β η ) - ( {t}_{1} + {t}_{3} )} ) - {Rbt}_{3} ,$$

where σᵣ is the interfacial tensile stress between the existing pipe and the mortar lining. Related meaning of the rest parameters is the same as above, which is not described repeatedly herein.

After the existing pipe is repaired according to the mortar lining wall thickness assumed value, the interfacial shearing stress between the existing pipe and the mortar lining is determined by the following equation:

$${τ}_{r} = \frac{{RF}_{Q}}{b \cdot ( R + {t}_{3} - {y}^{′} )} \cdot ( \frac{{E}_{3} {K}_{b}}{{E}_{1} {J}_{a} + {E}_{3} {J}_{b}} - \frac{1}{R} \cdot \frac{3 {E}_{1}^{2} {t}_{1}^{3} + 4 {E}_{1}^{2} {t}_{1}^{2} {t}_{3} + 3 {E}_{1} {E}_{3} {t}_{1}^{2} {t}_{3} + 5 {E}_{1} {E}_{3} {t}_{1} {t}_{3}^{2} + {E}_{3}^{2} {t}_{3}^{3}}{{E}_{1} {t}_{1} {t}_{3} \cdot ( {E}_{1} {t}_{1} + {E}_{3} {t}_{3} ) k} .$$

where τᵣ is the interfacial shearing stress between the existing pipe and the mortar lining. related meaning of the rest parameters is the same above, which is not described repeatedly herein.

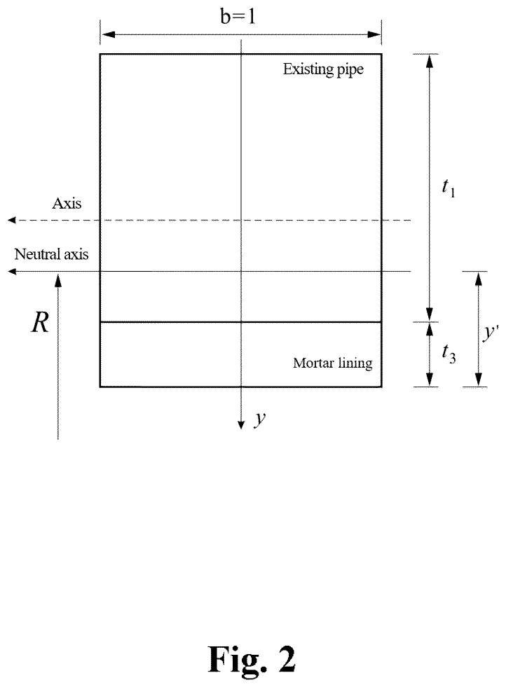

In an implementation scenario, the sectional schematic diagram of the repaired existing pipe can be shown in FIG. 2. FIG. 2 is a schematic diagram of a section of a pipe provided in an exemplary embodiment. As shown in FIG. 2, where the y′, R, Aₐ, and A_{b} involved in the stress state parameter are determined by the following equations:

$${y}^{′} = \frac{{E}_{1} {t}_{1}^{2} + 2 {E}_{1} {t}_{1} {t}_{3} + {E}_{3} {t}_{3}^{2}}{2 {E}_{1} {t}_{1} + 2 {E}_{3} {t}_{3}} , R = \frac{D}{2} + {y}^{′} - {t}_{1} - {t}_{3} , {A}_{a} = {t}_{1} \cdot b , {A}_{b} = {t}_{3} \cdot b ,$$

where b represents the unit length.

In an embodiment, the comparison result that the stress state parameter is consistent with the standard strength parameter includes: the pipe top inner wall tensile stress is equal to the tensile strength of the mortar lining, the interfacial tensile stress between the existing pipe and the mortar lining is less than or equal to the interfacial tensile strength between the existing pipe and the mortar lining, and the interfacial shearing stress between the existing pipe and the mortar lining is less than or equal to the interfacial shearing strength between the existing pipe and the mortar lining. The tensile strength is the standard strength parameter corresponding to the tensile stress; the interfacial tensile strength is the standard strength parameter corresponding to the interfacial tensile stress; and the interfacial shearing strength is the standard strength parameter corresponding to the interfacial shearing stress.

In an example, the tensile strength can be determined based on the maximum tensile stress theory. The tensile strength is K·σₜ, where K is a comprehensive safety coefficient, K∈1.5~2, and σₜ is the tensile strength of a repair material. The interfacial tensile strength is determined as K·σ_{b} and the interfacial shearing strength is determined as K·τ_{b} based on a coordination deformation judging criterion of the mortar lining-existing pipe. σ_{b} is the interfacial tensile strength between the existing pipe and the mortar lining, and τ_{b} is the interfacial shearing strength between the existing pipe and the mortar lining. In an implementation scenario, the fragile repair material is mainly mortar. Therefore, σₜ, σ_{b}, and τ_{b} can be measured and acquired based on a concrete splitting tensile strength test, a concrete bonding strength test, and a concrete shearing strength test in Hydraulic Concrete Test Regulation.

In an implementation scenario, if σₛ=K·σₜ, σᵣ≤K·σ_{b}, and τᵣ≤K≤τ_{b}, it is determined that the comparison result is that the stress state parameter is consistent with the standard strength parameter.

In another embodiment, the comparison result that the stress state parameter is inconsistent with the standard strength parameter includes: the pipe top inner wall tensile stress is not equal to the tensile strength of the mortar lining, the interfacial tensile stress is greater than the interfacial tensile strength between the existing pipe and the mortar lining, or the interfacial shearing stress is greater than the interfacial shearing strength between the existing pipe and the mortar lining. That is, at least one of the tensile stress, the interfacial tensile stress or the interfacial shearing stress is different from the corresponding standard strength parameter, it is determined that the stress state parameter is inconsistent with the standard strength parameter.

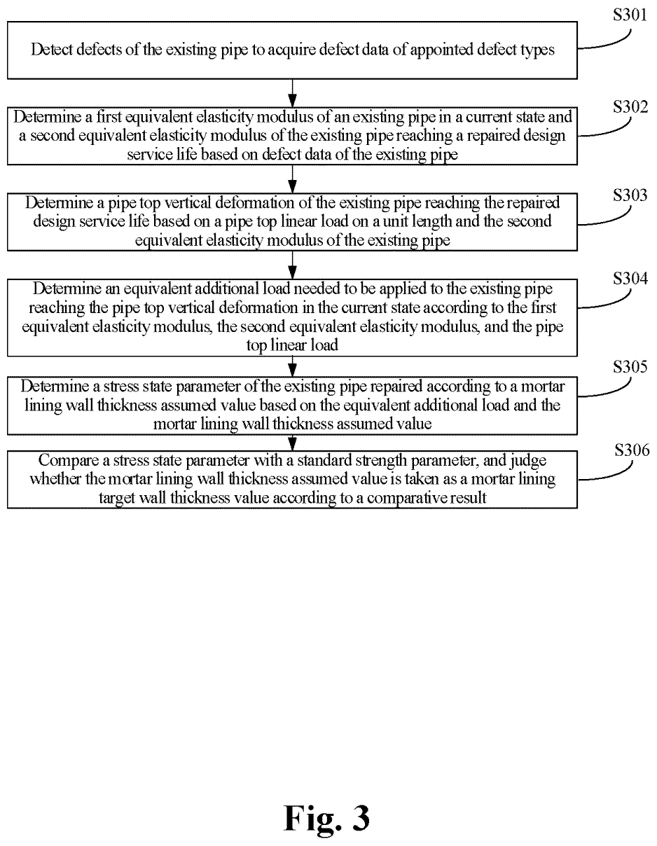

FIG. 3 is a flowchart of another mortar lining wall thickness design method provided in an exemplary embodiment. As shown in FIG. 3, the mortar lining wall thickness design method includes the following steps.

In step S301, defects of the existing pipe are detected to acquire defect data of appointed defect types.

In the embodiment of the present invention, the inner wall of the existing pipe is pre-treated in a hydraulic or mechanical manner, so that the defects of the existing pipe are detected by means of periscope detection (QV), closed circuit television (CCTV) detection, sonar detection or three-dimensional laser scanning detection and the like according to the defect types, and the defect types are identified and quantization parameters of the defects are counted, so as to acquire defect data of the existing pipe. The appointed defect types include corrosion defects and crack defects. The defects of the existing pipe are detected in a targeted manner according to the defect types, thereby facilitating targeted analysis when the mortar lining target wall thickness wall is subsequently determined. In an example, if the defect data of the corrosion defects and the crack defects are acquired at the same time, the defect data is separately determined when the equivalent additional load is determined. That is, the equivalent additional load corresponding to the corrosion defects is detected and the equivalent additional load corresponding to the crack defects is detected respectively based on the defect data based on the corrosion defects.

In step S302, the first equivalent elasticity modulus of an existing pipe in a current state and the second equivalent elasticity modulus of the existing pipe reaching the repaired design service life are determined based on defect data of the existing pipe.

In step S303, the pipe top vertical deformation of the existing pipe reaching the repaired design service life is determined based on the pipe top linear load on the unit length of the existing pipe and the second equivalent elasticity modulus.

In step S304, the equivalent additional load needed to be applied to the existing pipe reaching the pipe top vertical deformation in the current state is determined according to the first equivalent elasticity modulus, the second equivalent elasticity modulus, and the pipe top linear load.

In Step S305, the stress state parameter of the existing pipe repaired is determined according to the mortar lining wall thickness assumed value based on the equivalent additional load and the mortar lining wall thickness assumed value.

In step S306, the stress state parameter is compared with the standard strength parameter, and whether the mortar lining wall thickness assumed value is taken as a mortar lining target wall thickness value is determined according to the comparative result.

In an embodiment, if the appointed type defects are the corrosion defects, the defect data includes the number of the corrosion defects, the defect area of each of the corrosion defects, and the defect depth of each of the corrosion defects, so that the first equivalent elasticity modulus and the second equivalent elasticity modulus can be determined by the following way:

The first mean volume loss rate of the existing pipe in the current state is determined based on the attribute data of the existing pipe, the corrosion defect quantity, the defect area of each of the corrosion defects, and the defect depth of each of the corrosion defects. The first equivalent elasticity modulus of the existing pipe in the current state is obtained by the following equation according to the first mean volume loss rate. The second mean volume loss rate of the existing pipe reaching the repaired design service life is obtained according to the first mean volume loss rate, the first pipe age of the existing pipe in the current state, and the second pipe age of the existing pipe reaching the repaired design service life. The second equivalent elasticity modulus of the existing pipe reaching the repaired design service life is obtained according to the second mean volume loss rate.

Specifically, the number N of the corrosion defects in the existing pipe, the defect area S of each of the corrosion defects, and the defect depth h of each of the corrosion defects are respectively determined through the defect data of the existing pipe. The defects are counted by the following equation to determine the first mean volume loss rate f₁:

$${f}_{1} = \frac{{\sum }_{i = 1}^{N} {S}_{i} \cdot {h}_{i}}{π \cdot ( D - 2 {t}_{0} ) \cdot {t}_{0} \cdot L} ,$$

where D is the pipe outer diameter of the existing pipe; t₀ is an initial wall thickness of the existing pipe; L is a length of a detected pipe section of the existing pipe; N is the corrosion defect quantity in the detected pipe section of the existing pipe; Sᵢ is the defect area of each of the corrosion defects; and hᵢ is the defect depth of each of the corrosion defects.

The equivalent elasticity modulus E₁ of the existing pipe in the current state is obtained by the following equation according to the first mean volume loss rate f₁:

$${E}_{1} = ( 1 - 2 {v}_{0} ) \frac{12 {G}_{0} {K}_{0} ( 1 - {f}_{1} )}{4 {G}_{0} + 3 {G}_{0} {f}_{1}} ,$$

where v₀ is an initial Poisson's ratio of a tubular product pipe material of the existing pipe; G₀ is an initial shearing modulus of the tubular product pipe material; and K₀ is an initial volume modulus of the tubular product pipe material.

The second mean volume loss rate f₂ of the existing pipe reaching the repaired design service life by the following equation according to the first mean volume loss rate f₁, the first pipe age of the existing pipe in the current state, and the second pipe age of the existing pipe reaching the repaired design service life:

$${f}_{2} = {f}_{1} \cdot \frac{{Y}_{1} + {Y}_{2}}{{Y}_{1}} ,$$

where Y₁ is the first pipe age of the existing pipe in the current state, and Y₂ is the second pipe age of the existing pipe reaching the repaired design service life.

The second equivalent elasticity modulus E₂ of the existing pipe reaching the repaired design service life is obtained by the following equation according to the second mean volume loss rate:

$${E}_{2} = ( 1 - 2 {v}_{0} ) \frac{12 {G}_{0} {K}_{0} ( 1 - {f}_{2} )}{4 {G}_{0} + 3 {G}_{0} {f}_{2}} ,$$

the parameters are defined as above, which is not repeatedly described herein.

In another implementation, for the corrosion defects, the pipe top vertical deformation of the existing pipe reaching the repaired design service is determined by the following way:

the first mean residual wall thickness t₁ of the existing pipe in the current state is obtained according to the first mean volume loss rate f₁ and the initial wall thickness t₀ of the existing pipe, where t₁=f₁·t₀.

The first equivalent section inertia moment I₁ of the existing pipe in the current state is determined by the following equation according to the first mean residual wall thickness t₁:

$${I}_{1} = \frac{π \cdot {D}^{4} \cdot ( 1 - {a}_{1}^{4} )}{64} , {a}_{1} = \frac{D - 2 {t}_{1}}{D} ,$$

the parameters are defined as above, which is not repeatedly described herein.

The second mean residual wall thickness t₂ of the existing pipe in the current state is obtained according to the second volume loss rate f₂ and the initial wall thickness t₀ of the existing pipe. t₂=f₂·t₀.

The second equivalent section inertia moment I₂ of the existing pipe in the current state is determined by the following equation according to the second mean residual wall thickness t₂.

$${I}_{2} = \frac{π \cdot {D}^{4} \cdot ( 1 - {a}_{2}^{4} )}{64} , {a}_{2} = \frac{D - 2 {t}_{2}}{D} .$$

The pipe top vertical deformation Δ of the existing pipe reaching the repaired design service life is determined by the following equation according to the second equivalent elasticity modulus, the second equivalent section inertia moment, and the pipe top linear load qₛₒᵢₗ:

$$Δ = \frac{{q}_{soil} {D}^{4}}{192 {E}_{2} {I}_{2}} .$$

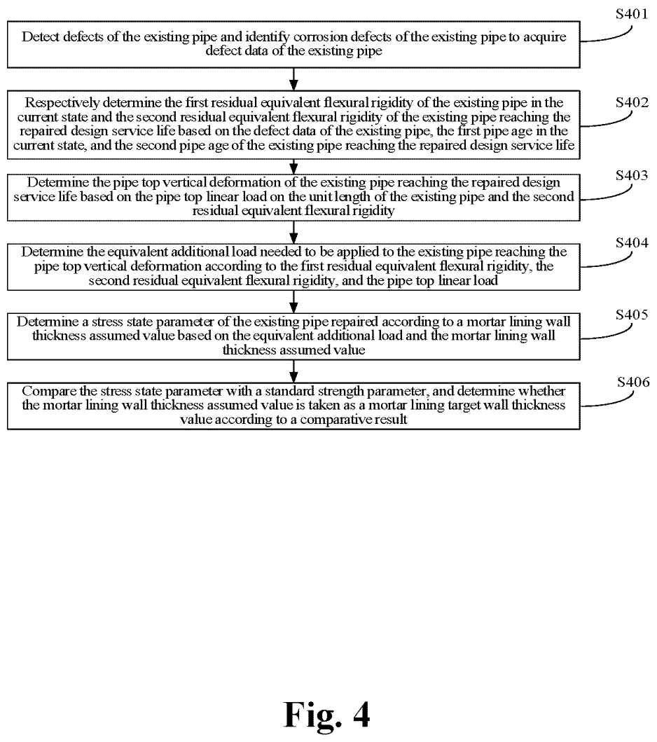

In an implementation scenario, the process of designing the mortar lining wall thickness for the corrosion defects can be shown in FIG. 4. FIG. 4 is a flowchart of yet another mortar lining wall thickness design method provided in an exemplary embodiment.

In step S401, the defects of the existing pipe are detected and corrosion defects of the existing pipe are identified to acquire defect data of the existing pipe.

In step S402, the first residual equivalent flexural rigidity of the existing pipe in the current state and the second residual equivalent flexural rigidity of the existing pipe reaching the repaired design service life are respectively determined based on the defect data of the existing pipe, the first pipe age in the current state, and the second pipe age of the existing pipe reaching the repaired design service life.

In the embodiment of the present invention, the number N of the corrosion defects in the existing pipe, the defect area S of each of the corrosion defects, and the defect depth h of each of the corrosion defects are respectively determined through the defect data of the existing pipe. The defects are counted by the following equation to determine the first mean volume loss rate f₁ and the first mean residual wall thickness t₁:

$${f}_{1} = \frac{{\sum }_{i = 1}^{N} {S}_{i} \cdot {h}_{i}}{π \cdot ( D - 2 {t}_{0} ) \cdot {t}_{0} \cdot L} , {t}_{1} - {f}_{1} \cdot {t}_{0} ,$$

where D is the pipe outer diameter of the existing pipe; t₀ is an initial wall thickness of the existing pipe; L is a length of a detected pipe section of the existing pipe; N is the corrosion defect quantity in the detected pipe section of the existing pipe; Sᵢ is the defect area of each of the corrosion defects; and hᵢ is the defect depth of each of the corrosion defects.

The second mean volume loss rate f₂ and the second mean residual wall thickness t₂ of the existing pipe reaching the repaired design service life by using the following equation based on the first mean volume loss rate, the first pipe age of the existing pipe in the current state, and the second pipe age of the existing pipe reaching the reaching the repaired design service life:

$${f}_{2} = {f}_{1} \cdot \frac{{Y}_{1} + {Y}_{2}}{{Y}_{1}} , {t}_{2} = {f}_{2} \cdot {t}_{0} ,$$

where Y₁ is the first pipe age of the existing pipe in the current state, and Y₂ is the second pipe age of the existing pipe reaching the repaired design service life.

The first equivalent elasticity modulus E₁ of the existing pipe in the current state and a second equivalent elasticity modulus E₂ of the existing pipe reaching the repaired design service life are respectively calculated based on defect data of the existing pipe by using the following equation:

$${E}_{i} = ( 1 - 2 {v}_{0} ) \frac{12 {G}_{0} {K}_{0} ( 1 - {f}_{i} )}{4 {G}_{0} + 3 {G}_{0} {f}_{i}} ,$$

where v₀ is an initial Poisson's ratio of a tubular product pipe material of the existing pipe; G₀ is an initial shearing modulus of the tubular product pipe material; K₀ is an initial volume modulus of the tubular product pipe material; i=1 corresponds to the current state of the existing pipe; and i=2 corresponds to the state when the existing pipe reaches the repaired design service life Y₂.

The first equivalent section inertia moment I₁ of the existing pipe in the current state and the second equivalent inertia moment I₂ of the existing pipe reaching the repaired design service life are respectively calculated based on defect data of the existing pipe by using the following equation:

$${I}_{i} = \frac{π \cdot {D}^{4} \cdot ( 1 - {a}_{i}^{4} )}{64} , {a}_{i} = \frac{D - 2 {t}_{i}}{D} .$$

The first residual equivalent flexural rigidity of the existing pipe in the current state is E₁I₁, and the second residual equivalent flexural rigidity of the existing pipe reaching the repaired design service life is E₂I₂.

In step S403, the pipe top vertical deformation of the existing pipe reaching the repaired design service life is determined based on the pipe top linear load on the unit length of the existing pipe and the second residual equivalent flexural rigidity.

In the embodiment of the present invention, the pipe top vertical deformation Δ of the existing pipe reaching the repaired design service life is determined by the following equation:

$$Δ = \frac{{q}_{soil} {D}^{4}}{192 {E}_{2} {I}_{2}} ,$$

where qₛₒᵢₗ is the pipe top linear load.

In step S404, the equivalent additional load needed to be applied to the existing pipe reaching the pipe top vertical deformation is determined according to the first residual equivalent flexural rigidity, the second residual equivalent flexural rigidity, and the pipe top linear load.

In the embodiment of the present invention, the equivalent additional load Δqₛₒᵢₗ needed to be applied to the existing pipe reaching the pipe top vertical deformation is determined by the following equation:

$$Δ {q}_{soil} = \frac{{E}_{1} {I}_{1}}{{E}_{2} {I}_{2}} \cdot {q}_{soil} .$$

In Step S405, the stress state parameter of the existing pipe repaired is determined according to the mortar lining wall thickness assumed value based on the equivalent additional load and the mortar lining wall thickness assumed value.

In the embodiment of the present invention, the pipe top section internal force of the repaired existing pipe can be determined based on the equivalent additional load, so that the stress state parameter of the existing pipe repaired according to the mortar lining wall thickness assumed value is determined based on the mortar lining wall thickness assumed value and the pipe top section internal force.

The pipe top sectional inner force can include a pipe top sectional bending moment M and a pipe top sectional shearing force F_{Q}. The bending moment can be determined by the following equation:

$$M = \frac{1}{16} \cdot Δ {q}_{soil} {D}^{2} ,$$

the pipe top section shearing force can be determined by the following equation:

$${F}_{Q} = \frac{1}{2} \cdot Δ {q}_{soil} D ,$$

where Δqₛₒᵢₗ represents the equivalent additional load, and D represents the pipe outer diameter of the existing pipe.

The stress state of the repaired existing pipe according to the mortar lining wall thickness assumed value includes: pipe top inner wall tensile stress σₛ, interfacial tensile stress σᵣ between the existing pipe and the mortar lining, and interfacial shearing stress τᵣ between the existing pipe and the mortar lining.

The pipe top inner wall tensile stress σₛ, the interfacial tensile stress σᵣ between the existing pipe and the mortar lining, and the interfacial shearing stress τᵣ between the existing pipe and the mortar lining are respectively determined by the following equations:

$${σ}_{s} = \frac{{ME}_{3}}{{E}_{1} {J}_{a} + {E}_{3} {J}_{b}} \cdot \frac{{Ry}^{′}}{R - {y}^{′}} - \frac{{ME}_{3}}{( {E}_{1} {A}_{a} + {E}_{3} {A}_{b} ) \cdot R} ,$$

$${σ}_{r} = ( \frac{{ME}_{3}}{{E}_{1} {J}_{a} + {E}_{3} {J}_{b}} \cdot {K}_{b} - \frac{{ME}_{3}}{( {E}_{1} {A}_{a} + {E}_{3} {A}_{b} ) \cdot R} \cdot {A}_{b} ) \cdot \frac{1}{b \cdot ( R + {t}_{3} - {y}^{′} )} ,$$

$${τ}_{r} = \frac{{RF}_{Q}}{b \cdot ( R + {t}_{3} - {y}^{′} )} \cdot ( \frac{{E}_{3} {K}_{b}}{{E}_{1} {J}_{a} + {E}_{3} {J}_{b}} - \frac{1}{R} \cdot \frac{3 {E}_{1}^{2} {t}_{1}^{3} + 4 {E}_{1}^{2} {t}_{1}^{2} {t}_{3} + 3 {E}_{1} {E}_{3} {t}_{1}^{2} {t}_{3} + 5 {E}_{1} {E}_{3} {t}_{1} {t}_{3}^{2} + {E}_{3}^{2} {t}_{3}^{3}}{{E}_{1} {t}_{1} {t}_{3} \cdot ( {E}_{1} {t}_{1} + {E}_{3} {t}_{3} ) k} ) ,$$

$${J}_{a} = {R}^{3} b \cdot ln ( 1 + \frac{2 {t}_{1} ( 1 + β η )}{2 R - {t}_{1} + ( 2 R + {t}_{3} ) \cdot β η} ) + {Rbt}_{1} \cdot ( \frac{β η \cdot ( {t}_{1} + {t}_{3} )}{2 + 2 β η} - R ) ,$$

$${J}_{b} = {R}^{3} b \cdot ln ( 1 + \frac{2 {t}_{e} ( 1 + β η )}{2 R - {t}_{1} + ( 2 R + {t}_{3} ) \cdot β η - 2 {t}_{3}} ) - {Rbt}_{3} \cdot ( \frac{1 + β}{2 + 2 β η} \cdot {t}_{1} + R ) ,$$

$${K}_{b} = {R}^{2} b \cdot ln ( 1 + \frac{2 {t}_{3} ( 1 + β η )}{( 2 R - {t}_{3} ) \cdot ( 1 + β η ) - ( {t}_{1} + {t}_{3} )} ) - {Rbt}_{3} ,$$

$$k = 4 + 6 \cdot \frac{{t}_{1}}{{t}_{3}} + 4 \cdot {( \frac{{t}_{1}}{{t}_{3}} )}^{2} + \frac{{E}_{1}}{{E}_{3}} \cdot {( \frac{{t}_{1}}{{t}_{3}} )}^{3} + \frac{{E}_{1}}{{E}_{3}} \cdot \frac{{t}_{1}}{{t}_{3}} ,$$

$$β = \frac{{t}_{3}}{{t}_{1}} , η = \frac{{E}_{3}}{{E}_{1}} ,$$

where R is the radius of the equivalent neutral axis of the repaired existing pipe; y′ is the distance between the equivalent neutral axis of the repaired existing pipe and the inner wall of the mortar lining; E₁ is the first equivalent elasticity modulus; E₃ is the elasticity modulus of the mortar lining; t₁ is the first mean residual wall thickness of the existing pipe in the current state; Aₐ is the sectional area of the existing pipe within a unit length; and A_{b} is the sectional area of the mortar lining with the unit length.

In an example, the y′, R, Aₐ, and A_{b} are determined by the following equations:

$${y}^{′} = \frac{{E}_{1} {t}_{1}^{2} + 2 {E}_{1} {t}_{1} {t}_{3} + {E}_{3} {t}_{3}^{2}}{2 {E}_{1} {t}_{1} + 2 {E}_{3} {t}_{3}} , R = \frac{D}{2} + {y}^{′} - {t}_{1} - {t}_{3} , {A}_{a} = {T}_{1} \cdot b , {A}_{b} = {t}_{3} \cdot b ,$$

where b represents the unit length.

In step S406, the stress state parameter is compared with the standard strength parameter, and whether the mortar lining wall thickness assumed value is taken as a mortar lining target wall thickness value is determined according to the comparative result.

In the embodiment of the present invention, the tensile strength (K·σₜ) is the standard strength parameter corresponding to the tensile stress as, the interfacial tensile strength (K·σ_{b}) is the standard strength parameter corresponding to the interfacial tensile stress σᵣ, and the interfacial shearing strength (K·τ_{b}) is the standard strength parameter corresponding to the interfacial shearing stress τᵣ. K is the comprehensive safety coefficient, K∈1.5~2, σ_{b} is the interfacial tensile strength between the existing pipe and the mortar lining, and τ_{b} is the interfacial shearing strength between the existing pipe and the mortar lining. The tensile stress can be determined based on the maximum tensile stress, and the interfacial tensile strength and the interfacial shearing strength can be determined according to the coordination deformation judging criterion of the mortar lining-existing pipe.

If σₛ=K·σₜ, σᵣ≤K·σ₁, and τᵣ≤K·τ_{b}, the comparative result is that the stress state parameter is consistent with the standard strength parameter, so that the mortar lining wall thickness assumed value is taken as the mortar lining target wall thickness value.

If at least one of the tensile stress, the interfacial tensile stress or the interfacial shearing stress is different from the corresponding standard strength parameter, it is determined that the stress state parameter is inconsistent with the standard strength parameter, so that the mortar lining wall thickness assumed value is re-determined, so as to re-determine the stress state parameter based on the re-determined mortar lining wall thickness assumed value.

In an embodiment, if the appointed defect types are the crack defects, the defect data includes a crack length, a crack depth, and a cracking angle, so that the first equivalent elasticity modulus and the second equivalent elasticity modulus can be determined by the following way:

An axial crack factor ρ₁ and a circular crack factor ρ₂ of the crack defect of the existing pipe can be determined based on the crack length l, the crack depth h, and the cracking angle θ. Splitting tensile strength data σ₁ of the existing pipe in the current state can be determined based on the axial crack factor ρ₁, a circular crack factor ρ₂, and initial splitting tensile strength data σ₀ of the existing pipe. The first equivalent elasticity modulus E₁ of the existing pipe in the current state is determined according to the splitting tensile strength data σ₁ in the current state. The second equivalent elasticity modulus E₂ of the existing pipe reaching the repaired design service life is determined based on the first pipe age Y₁, the second pipe age Y₂, and the first equivalent elasticity modulus E₁ of the existing pipe, where

$${ρ}_{1} = 1 - \frac{{h}_{2}}{{t}_{0}} + \frac{{h}_{2}}{{t}_{0} \cdot ψ} , ψ = \sqrt{1 + \frac{3.22 \cdot {l}^{2}}{D \cdot {h}_{2}}} , {ρ}_{2} = \frac{{t}_{0} \cdot β - {h}_{1} \cdot β}{{t}_{0} \cdot β - {h}_{1}} ,$$

$$β = \sqrt{1 + 0.26 \cdot ( θ / π ) + 47 \cdot {( θ / π )}^{2} - 59 \cdot {( θ / π )}^{3}} ,$$

$${σ}_{1} = {σ}_{0} \cdot {ρ}_{1} \cdot {ρ}_{2} , {E}_{1} = \frac{9.15 \cdot {10}^{5} \cdot {σ}_{1}^{\frac{4}{3}}}{20.13 \cdot {σ}_{1}^{\frac{4}{3}} + 34.7} , {E}_{2} = \frac{{Y}_{1} + {Y}_{2}}{{Y}_{1}} \cdot {E}_{1} ,$$

l is the axial crack length; θ is the cracking angle of the circular crack; h₁ is the depth of the axial crack defect; and h₂ is the depth of the circular crack defect.

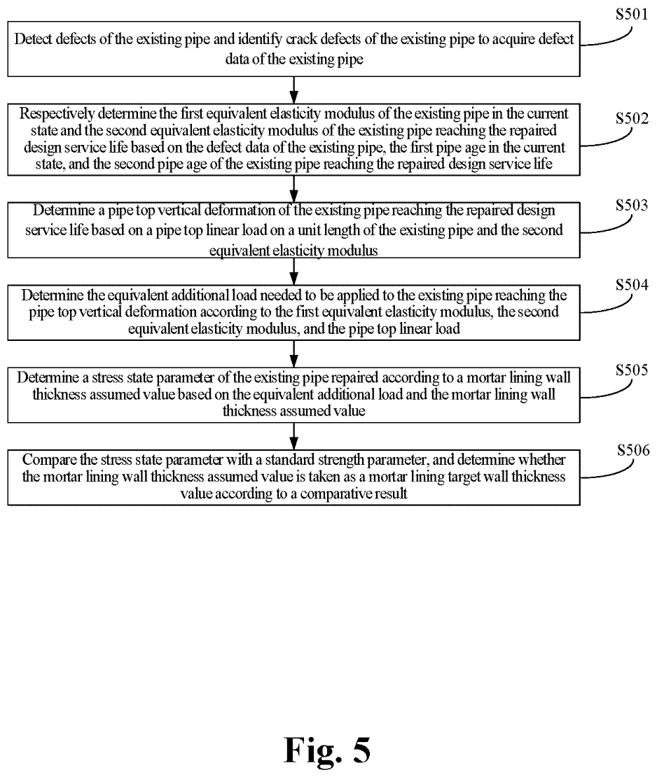

In an implementation scenario, the process of designing the mortar lining wall thickness for the crack defects can be shown in FIG. 5. FIG. 5 is a flowchart of yet another mortar lining wall thickness design method provided in an exemplary embodiment.

In step S501, the defects of the existing pipe are detected and crack defects of the existing pipe are identified to acquire defect data of the existing pipe.

In step S502, the first equivalent elasticity modulus of the existing pipe in the current state and the second equivalent elasticity modulus of the existing pipe reaching the repaired design service life are respectively determined based on the defect data of the existing pipe, the first pipe age in the current state, and the second pipe age of the existing pipe reaching the repaired design service life.

In the embodiment of the present invention, the crack length, the crack depth, and the cracking angle of the existing pipe are respectively determined according to the defect data, so that the axial crack factor ρ₁ and the circular crack factor ρ₂ of the crack defect are determined. The splitting tensile strength data σ₁ of the existing pipe in the current state is determined based on the axial crack factor ρ₁, a circular crack factor ρ₂, and the initial splitting tensile strength data σ₀ of the existing pipe. The first equivalent elasticity modulus E₁ of the existing pipe in the current state is determined according to the splitting tensile strength data σ₁ in the current state. The second equivalent elasticity modulus E₂ of the existing pipe reaching the repaired design service life is determined based on the first pipe age Y₁, the second pipe age Y₂, and the first equivalent elasticity modulus E₁ of the existing pipe, where

$${ρ}_{1} = 1 - \frac{{h}_{2}}{{t}_{0}} + \frac{{h}_{2}}{{t}_{0} \cdot ψ} , ψ = \sqrt{1 + \frac{3.22 \cdot {l}^{2}}{D \cdot {h}_{2}}} , {ρ}_{2} = \frac{{t}_{0} \cdot β - {h}_{1} \cdot β}{{t}_{0} \cdot β - {h}_{1}} ,$$

$$β = \sqrt{1 + 0.26 \cdot ( θ / π ) + 47 \cdot {( θ / π )}^{2} - 59 \cdot {( θ / π )}^{3}} ,$$

$${σ}_{1} = {σ}_{0} \cdot {ρ}_{1} \cdot {ρ}_{2} , {E}_{1} = \frac{9.15 \cdot {10}^{5} \cdot {σ}_{1}^{\frac{4}{3}}}{20.13 \cdot {σ}_{1}^{\frac{4}{3}} + 34.7} , {E}_{2} = \frac{{Y}_{1} + {Y}_{2}}{{Y}_{1}} \cdot {E}_{1} ,$$

l is the axial crack length; θ is the cracking angle of the circular crack; h₁ is the depth of the axial crack defect; and h₂ is the depth of the circular crack defect.

In step S503, the pipe top vertical deformation of the existing pipe reaching the repaired design service life is determined based on the pipe top linear load on the unit length of the existing pipe and the second equivalent elasticity modulus.

In the embodiment of the present invention, the pipe top vertical deformation Δ of the existing pipe reaching the repaired design service life is determined by the following equation:

$$Δ = \frac{{q}_{soil} {D}^{4}}{192 {E}_{2} {I}_{2}} , {I}_{0} = \frac{π \cdot {D}^{4} \cdot ( 1 - {a}_{0}^{4} )}{64} , {a}_{0} = \frac{D - 2 {t}_{0}}{D} ,$$

where I₀ is the initial sectional inertia moment of the existing pipe.

In an example, when the crack defect is repaired by spraying the mortar, the sectional inertia moment of the existing pipe does not change with time.

In step S504, the equivalent additional load needed to be applied to the existing pipe reaching the pipe top vertical deformation is determined according to the first equivalent elasticity modulus, the second equivalent elasticity modulus, and the pipe top linear load.

In the embodiment of the present invention, the equivalent additional load is determined by the following equation:

$$Δ {q}_{soil} = \frac{{E}_{1} {I}_{1}}{{E}_{2} {I}_{2}} \cdot {q}_{soil} ,$$

Δqₛₒᵢₗ is the equivalent additional load, E₁ is the first equivalent elasticity modulus, I₁ is the first equivalent section inertia moment, E₂ is the second equivalent elasticity modulus, I₂ is the second equivalent section inertia moment, and qₛₒᵢₗ is the pipe top linear load.

In Step S505, the stress state parameter of the existing pipe repaired is determined according to the mortar lining wall thickness assumed value based on the equivalent additional load and the mortar lining wall thickness assumed value. A specific implementation mode of the step is as same as that in the step S405, which is not repeatedly described herein.

In step S506, the stress state parameter is compared with the standard strength parameter, and whether the mortar lining wall thickness assumed value is taken as a mortar lining target wall thickness value is determined according to the comparative result. A specific implementation mode of the step is as same as that in the step S406, which is not repeatedly described herein.

Based on a same inventive concept, the present invention further provides a pipe repairing method.

FIG. 6 is a flowchart of yet another pipe repairing method provided in an exemplary embodiment. As shown in FIG. 6, the pipe repairing method includes the following steps S601 to S602.

In step S601, the mortar lining target wall thickness value is acquired when the existing pipe is repaired by spraying the mortar.

In the embodiment of the present invention, the mortar lining target wall thickness value is determined by any one mortar lining wall thickness design method provided by the present invention.

In step S602, the lining of the existing pipe is repaired by spraying the mortar according to the mortar lining target wall thickness value.

Through the above embodiment, the existing pipe is repaired by spraying the mortar according to the mortar lining target wall thickness value, so that the obtained mortar lining target wall thickness value further meets the actual engineering condition, therefore, it is capable to effectively reduce the mortar lining wall thickness on the premise of ensuring that the structural strength of the repaired pipe meets a requirement, thereby further lowering the costs of engineering materials.

Based on the same inventive concept, the present invention further provides a mortar lining wall thickness design device.

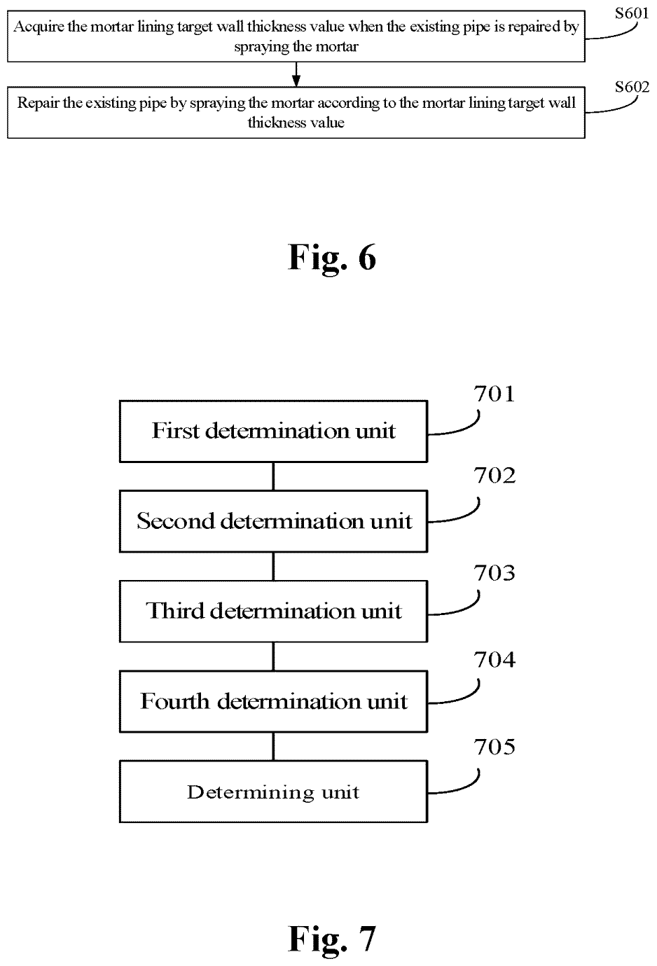

FIG. 7 is a structural block diagram of a mortar lining wall thickness design method provided in an exemplary embodiment. As shown in FIG. 7, the mortar lining wall thickness design device includes a first determination unit 701, a second determination unit 702, a third determination unit 703, a fourth determination unit 704, and a determining unit 705.

The first determination unit 701 is configured to determine a first equivalent elasticity modulus of an existing pipe in a current state and a second equivalent elasticity modulus of the existing pipe reaching a repaired design service life based on defect data of the existing pipe;
the second determination unit 702 is configured to determine a pipe top vertical deformation of the existing pipe reaching the repaired design service life based on a pipe top linear load on a unit length and the second equivalent elasticity modulus of the existing pipe;
the third determination unit 703 is configured to determine an equivalent additional load needed to be applied to the existing pipe reaching the pipe top vertical deformation in the current state according to the first equivalent elasticity modulus, the second equivalent elasticity modulus, and the pipe top linear load;
the fourth determination unit 704 is configured to determine a stress state parameter of the existing pipe repaired according to a mortar lining wall thickness assumed value based on the equivalent additional load and the mortar lining wall thickness assumed value; and
the determining unit 705 is configured to compare the stress state parameter with a standard strength parameter, and to determine whether the mortar lining wall thickness assumed value is taken as a mortar lining target wall thickness value according to a comparative result.

In an embodiment, the determining unit 705 includes: a first determining unit, configured to determine that the mortar lining wall thickness assumed value is taken as the mortar lining target wall thickness value if the comparison result is that the stress state parameter is consistent with the standard strength parameter; and a second determining unit, configured to re-determining the mortar lining wall thickness assumed value to re-determine the stress state parameter based on the re-determined mortar lining wall thickness assumed value if the comparative result is that the stress state parameter is inconsistent with the standard strength parameter.

In another embodiment, the fourth determination unit 704 includes: a pipe top sectional internal force determination unit, configured to determine the pipe top sectional internal force of the repaired existing pipe under the equivalent load effect based on the equivalent additional load; and a stress state parameter determination unit, configured to determine a stress state parameter of the existing pipe repaired according to the mortar lining wall thickness assumed value based on the mortar lining wall thickness assumed value and the pipe top sectional internal force.

In yet another embodiment, the pipe top sectional inner force includes a pipe top sectional bending moment and a pipe top sectional shearing force. The stress state parameter determination unit includes a first stress state parameter determination subunit, configured to determine pipe top inner wall tensile stress of the existing pipe repaired according to the mortar lining wall thickness assumed value based on the mortar lining wall thickness assumed value, the pipe top sectional bending moment, and the attribute data of the existing pipe; a second stress state parameter determination subunit, configured to determine interfacial tensile stress of the existing pipe repaired according to the mortar lining wall thickness assumed value based on the mortar lining wall thickness assumed value, the pipe top sectional bending moment, and the attribute data of the existing pipe; and a third stress state parameter determination subunit, configured to determine interfacial shearing stress of the existing pipe repaired according to the mortar lining wall thickness assumed value based on the mortar lining wall thickness assumed value, the pipe top sectional shearing force, and the attribute data of the existing pipe. The pipe top inner wall tensile stress, the interfacial tensile stress, and the interfacial shearing stress all are stress state parameters.

In yet another embodiment, the stress state parameter is consistent with the standard strength parameter, which includes: the pipe top inner wall tensile stress is equal to the tensile strength of the mortar lining, the interfacial tensile stress between the existing pipe and the mortar lining is less than or equal to the interfacial tensile strength between the existing pipe and the mortar lining, and the interfacial shearing stress between the existing pipe and the mortar lining is less than or equal to the interfacial shearing strength between the existing pipe and the mortar lining. The third stress state parameter determination subunit is configured to determine the interfacial shearing stress of the existing pipe repaired according to the mortar lining wall thickness assumed value based on the mortar lining wall thickness assumed value, the pipe top sectional shearing force, and the attribute data of the existing pipe. The tensile strength is the standard strength parameter corresponding to the tensile stress; the interfacial tensile strength is the standard strength parameter corresponding to the interfacial tensile stress; and the interfacial shearing strength is the standard strength parameter corresponding to the interfacial shearing stress.

In yet another embodiment, the stress state parameter is inconsistent with the standard strength parameter, including: the pipe top inner wall tensile stress is not equal to the tensile strength of the mortar lining. The interfacial tensile stress is greater than the interfacial tensile strength between the existing pipe and the mortar lining. Or the interfacial shearing stress is greater than the interfacial shearing strength between the existing pipe and the mortar lining.

In yet another embodiment, the device further includes a detection unit, configured to detect defects of the existing pipe to acquire defect data of appointed defect types. The defect types include corrosion defects and/or crack defects.

In yet another embodiment, if the appointed defect types are corrosion defects, the defect data includes a corrosion defect quantity, a defect area of each of the corrosion defects, and a defect depth of each of the corrosion defects; the first determination unit 701 includes a first loss rate determination unit, configured to determine the first mean volume loss rate of the existing pipe in the current state based on the attribute data of the existing pipe, the corrosion defect quantity, the defect area of each of the corrosion defects, and the defect depth of each of the corrosion defects; a first elasticity modulus determination unit, configured to obtain the first equivalent elasticity modulus of the existing pipe in the current state according to the first mean volume loss rate; a second loss rate determination unit, configured to obtain the second mean volume loss rate of the existing pipe reaching the repaired design service life according to the first mean volume loss rate, the first pipe age of the existing pipe in the current state, and the second pipe age of the existing pipe reaching the repaired design service life; and a second equivalent elasticity modulus determination unit, configured to obtain the second equivalent elasticity modulus of the existing pipe reaching the repaired design service life according to the second mean volume loss rate.

In yet another embodiment, the second determination unit 702 includes a first residual wall thickness determination unit, configured to determine the first mean residual wall thickness of the existing pipe in the current state according to the first mean volume loss rate and the initial wall thickness of the existing pipe; a first sectional inertia moment determination unit, configured to determine the first equivalent inertia moment of the existing pipe in the current state according to the first mean volume loss rate; a second sectional inertia moment determination unit, configured to obtain the second mean residual wall thickness of the existing pipe in the current state according to the second volume loss rate and the initial wall thickness of the existing pipe; a second equivalent section inertia moment determination unit, configured to determine the second equivalent section inertia moment of the existing pipe in the current state according to the second mean residual wall thickness; and a second determination unit, configured to determine the pipe top vertical deformation of the existing pipe reaching the repaired design service life according to the second equivalent elasticity modulus, the second equivalent section inertia moment, and the pipe top linear load.

In yet another embodiment, if the appointed defect types are the crack defects, the defect data includes a crack length, a crack depth, and a cracking angle. The first determination unit 701 includes a splitting tensile strength data determination unit, configured to determine a splitting tensile strength of the existing pipe in the current state based on the crack length, the crack depth, the cracking angle, and initial splitting tensile strength data of the existing pipe; a third equivalent elasticity modulus determination unit, configured to determine the first equivalent elasticity modulus of the existing pipe in the current state according to the splitting tensile strength data in the current state; and the fourth equivalent elasticity modulus determination unit, configured to determine the second equivalent elasticity modulus of the existing pipe reaching the repaired design service life based on the first pipe age, the second pipe age, and the first equivalent elasticity modulus of the existing pipe.

Specific definition and beneficial effects of the above mortar lining wall thickness design device can refer to the definition of the mortar lining wall thickness design method above, which is not described in detail herein. The above modules can be fully or partially achieved by means of software, hardware, and a combination thereof. The above modules can be embedded into a processor in a computer device in the form of hardware or can be independent from the processor in the computer device, and can also be stored in a memory in the computer device in the form of software, for the convenience of the process to call corresponding operations to execute the above modules.

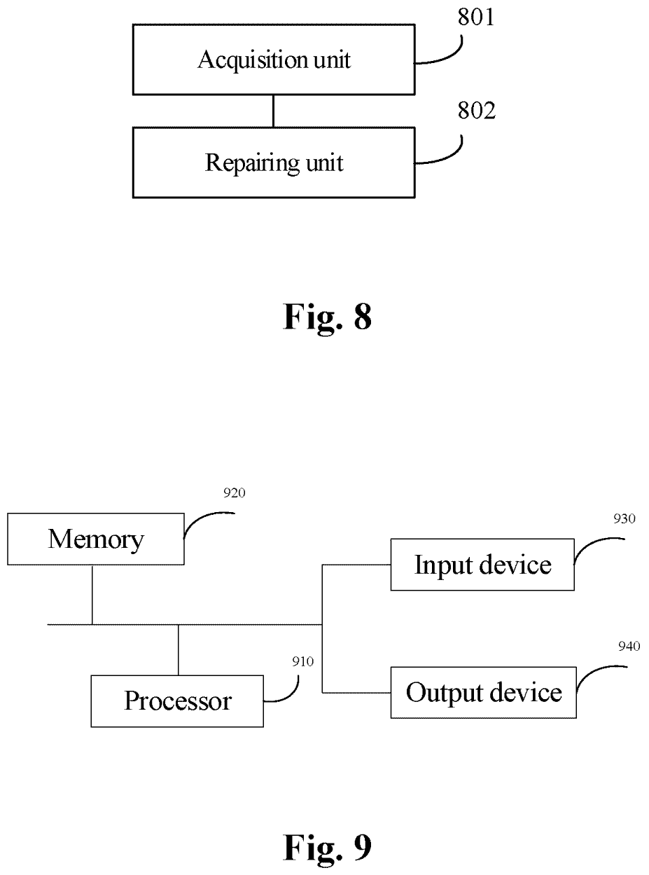

FIG. 8 is a structural block diagram of a pipe repairing device provided in an exemplary embodiment. As shown in FIG. 8, the pipe repairing device includes an acquisition unit 801 and a repairing unit 802.

The acquisition unit 801 is configured to acquire a mortar lining target wall thickness value when mortar is sprayed to repair an existing pipe, where the mortar lining target wall thickness value is determined by any one of the mortar lining wall thickness design methods provided by the present invention.

The repairing unit 802 is configured to spray mortar to repair the existing pipe according to the mortar lining target wall thickness value.

Specific definition and beneficial effects of the above pipe repairing device can refer to the definition of the pipe repairing method, which is not described in detail herein. The above modules can be fully or partially achieved by means of software, hardware, and a combination thereof. The above modules can be embedded into a processor in a computer device in the form of hardware or can be independent from the processor in the computer device, and can also be stored in a memory in the computer device in the form of software, for the convenience of the process to call corresponding operations to execute the above modules.

FIG. 9 is a schematic diagram of a hardware structure of a computer device provided in an exemplary embodiment. As shown in FIG. 9, the device includes one or more processors 910 and memories 920. The memories 920 include persistent memories, volatile memories, and hardware. In FIG. 9, one processor 910 is taken as an example. The device can further include an input device 930 and an output device 940.

The processor 910, the memory 920, the input device 930 and the output device 940 may be connected via a bus or other ways, and FIG. 9 shows an example of connection via the bus.

The processor 910 can be a central processing unit (CPU). The processor 910 can also be a chip such as another general processor, a digital signal processor (DSP), an application specific integrated circuit (ASIC), a field-programmable gate array (FPGA), or another programmable logic device, a discrete gate or transistor logic device, or a discrete hardware component, or a combination of the foregoing chips. The universal processor may be a microprocessor or the processor may also be any conventional processor and the like.

The memory 920 as a non-transient computer-readable storage medium includes the persistent memory, the volatile memory, and the hardware and can be used to store a non-transient software program, a non-transient computer executable program and a module, for example, a program instruction/module corresponding to the service management method in the embodiments of the present disclosure. The processor 910 executes various functional applications and data processing of the electronic device by running the non-transient software program, the instruction, and the module stored in the memory 920, that is, implements the above any one of the mortar lining wall thickness design method or the pipe repair method.

The memory 920 can include a storage program region and a storage data region, where the storage program region can store an operating system and an application program needed by at least one function. The storage data region can store bases, data needed to use, and the like. In addition, the memory 920 can include a high-speed random access memory and can further include a non-transient memory, for example, at least one disk memory device, a flash memory device or another non-transient solid memory device. In some embodiments, the memory 920 may be selected from a memory arranged remotely relative to the processor 910, and the remote memories can be connected to a data processing device via a network. Examples of such networks comprise, but are not limited to, the Internet, intranets, local area networks, mobile communication networks, and combinations thereof.

The input device 930 can receive input figure or character information and generates key signal input associated with user settings and function control. The output device 940 can include a display device such as a display screen.

One or more modules are stored in the memory 920. When executed by one or more processors 910, the one or more modules execute the method shown in FIGS. 1-6.

The product can execute the method provided by the embodiments of the present invention and has the functional modules and beneficial effects corresponding to the executed method. Technical details not described in detail in the embodiment can specifically refer to related descriptions in the embodiments shown in FIGS. 1-6.

The embodiment of the present invention further provides a non-transient computer-readable storage medium, storing a computer executable instruction. The computer executable instruction can implement the authentication method in any method embodiment above. The storage medium can be a disk, an optical disk, a read-only memory (ROM), a random access memory (RAM), a flash memory, a hard disk drive (HDD) or a solid-state drive (SSD), and the like. the storage medium can further include a combination of the above types of memories.

1. A mortar lining wall thickness design method, comprising:
determining a first equivalent elasticity modulus of an existing pipe in a current state and a second equivalent elasticity modulus of the existing pipe reaching a repaired design service life based on defect data of the existing pipe;
determining a pipe top vertical deformation of the existing pipe reaching the repaired design service life based on a pipe top linear load on a unit length of the existing pipe and the second equivalent elasticity modulus;
determining an equivalent additional load needed to be applied to the existing pipe reaching the pipe top vertical deformation in the current state according to the first equivalent elasticity modulus, the second equivalent elasticity modulus, and the pipe top linear load;
determining a stress state parameter of the existing pipe repaired according to a mortar lining wall thickness assumed value based on the equivalent additional load and the mortar lining wall thickness assumed value; and
comparing the stress state parameter with a standard strength parameter, and determining whether the mortar lining wall thickness assumed value is taken as a mortar lining target wall thickness value according to a comparative result;
wherein the determining a stress state parameter of the existing pipe repaired according to a mortar lining wall thickness assumed value based on the equivalent additional load and the mortar lining wall thickness assumed value comprises: determining a pipe top section internal force of the repaired existing pipe under the action of the equivalent additional load based on the equivalent additional load; and determining the stress state parameter of the existing pipe repaired according to the mortar lining wall thickness assumed value based on the mortar lining wall thickness assumed value and the pipe top section internal force;
the pipe top section internal force comprises a pipe top section bending moment and a pipe top section shearing force; the determining the stress state parameter of the existing pipe repaired according to the mortar lining wall thickness assumed value based on the mortar lining wall thickness assumed value and the pipe top section internal force comprises: determining a pipe top inner wall tensile stress of the mortar lining of the existing pipe repaired according to the mortar lining wall thickness assumed value based on the mortar lining wall thickness assumed value, the pipe top section bending moment, and attribute data of the existing pipe; determining an interfacial tensile stress between the existing pipe and the mortar lining of the existing pipe repaired according to the mortar lining wall thickness assumed value based on the mortar lining wall thickness assumed value, the pipe top section bending moment, and the attribute data of the existing pipe; and determining an interfacial shearing stress between the existing pipe and the mortar lining of the existing pipe repaired according to the mortar lining wall thickness assumed value based on the mortar lining wall thickness assumed value, the pipe top section shearing force, and the attribute data of the existing pipe, wherein the pipe top inner wall tensile stress, the interfacial tensile stress, and the interfacial shearing stress all belong to the stress state parameters;
wherein the pipe top section bending moment is determined by the following equation:
$$M = \frac{1}{16} \cdot Δ {q}_{soil} {D}^{2} ,$$
where M represents the pipe top section bending moment, Δqₛₒᵢₗ represents the equivalent additional load, and D represents a pipe outer diameter of the existing pipe;
the pipe top section shearing force is determined by the following equation:
$${F}_{Q} = \frac{1}{2} \cdot Δ {q}_{soil} D ,$$
where F_{Q} is the pipe top section shearing force;
if an equivalent section inertia moment of the existing pipe in a service process does not change, the equivalent additional load is determined by the following equation:
$$Δ {q}_{soil} = \frac{{E}_{1}}{{E}_{2}} \cdot {q}_{soil} ,$$
Δqₛₒᵢₗ is the equivalent additional load, E₁ is the first equivalent elasticity modulus, E₂ is the second equivalent elasticity modulus, and qₛₒᵢₗ is the pipe top linear load;
if the equivalent section inertia moment of the existing pipe in the service process changes with increase of a service life, a first equivalent flexural rigidity of the existing pipe in the current state is determined in combination with a first equivalent section inertia moment and the first equivalent elasticity modulus of the existing pipe in the current state; a second equivalent flexural rigidity of the existing pipe reaching the repaired design service life is determined in combination with a second equivalent section inertia moment of the existing pipe reaching the repaired design service life and the second equivalent elasticity modulus; the equivalent additional load is determined by the following equation:
$$Δ {q}_{soil} = \frac{{E}_{1} {I}_{1}}{{E}_{2} {I}_{2}} \cdot {q}_{soil} ,$$
Δqₛₒᵢₗ is the equivalent additional load, E₁ is the first equivalent elasticity modulus, I₁ is the first equivalent section inertia moment, E₂ is the second equivalent elasticity modulus, I₂ is the second equivalent section inertia moment, and qₛₒᵢₗ is the pipe top linear load;
the pipe top inner wall tensile stress is determined by the following equations:
$${σ}_{s} = \frac{M {E}_{3}}{{E}_{1} {J}_{a} + {E}_{3} {J}_{b}} \cdot \frac{R {y}^{′}}{R - {y}^{′}} - \frac{M {E}_{3}}{( {E}_{1} {A}_{a} + {E}_{3} {A}_{b} ) \cdot R} ,$$
$${J}_{a} = {R}^{3} b \cdot ln ( 1 + \frac{2 {t}_{1} ( 1 + β η )}{2 R - {t}_{1} + ( 2 R + {t}_{3} ) \cdot β η} ) + {Rbt}_{1} \cdot ( \frac{βη \cdot ( {t}_{1} + {f}_{3} )}{2 + 2 β η} - R ) ,$$
$${J}_{b} = {R}^{3} b \cdot ln ( 1 + \frac{2 {t}_{3} ( 1 + β η )}{2 R - {t}_{1} + ( 2 R - {t}_{3} ) \cdot βη - 2 {t}_{3}} ) - R b {t}_{3} \cdot ( \frac{1 + β}{2 + 2 β η} \cdot {t}_{1} + R ) ,$$
$$β = \frac{{t}_{3}}{{t}_{1}} , η = \frac{{E}_{3}}{{E}_{1}} ,$$
where σₛ is the pipe top inner wall tensile stress, and R is a radius of an equivalent neutral axis of the repaired existing pipe; y′ is a distance between the equivalent neutral axis of the repaired existing pipe and the inner wall of the mortar lining; E₁ is the first equivalent elasticity modulus; E₃ is the elasticity modulus of the mortar lining; t₁ is a first mean residual wall thickness of the existing pipe in the current state; t₃ is the mortar lining wall thickness assumed value; Aₐ is a sectional area of the existing pipe within a unit length; and A_{b} is a sectional area of the mortar lining with the unit length;
the interfacial tensile stress between the existing pipe and the mortar lining is determined by the following equations:
$${σ}_{r} = ( \frac{{ME}_{3}}{{E}_{1} {J}_{a} + {E}_{3} {J}_{b}} \cdot {K}_{b} - \frac{{ME}_{3}}{( {E}_{1} {A}_{a} + {E}_{3} {A}_{b} ) \cdot R} \cdot {A}_{b} ) \cdot \frac{1}{b \cdot ( R + {t}_{3} - {y}^{′} )} ,$$
$${K}_{b} = {R}^{2} b \cdot ln ( 1 + \frac{2 {t}_{3} ( 1 + β η )}{( 2 R - {t}_{3} ) \cdot ( 1 + β η ) - ( {t}_{1} + {t}_{3} )} ) - {Rbt}_{3} ,$$
where σᵣ is the interfacial tensile stress between the existing pipe and the mortar lining;
the interfacial shearing stress between the existing pipe and the mortar lining is determined by the following equations:
$${τ}_{r} = \frac{{RF}_{Q}}{b \cdot ( R + {t}_{3} - {y}^{′} )} \cdot ( \frac{{E}_{3} {K}_{b}}{{E}_{1} {J}_{a} + {E}_{3} {J}_{b}} - \frac{1}{R} \cdot \frac{3 {E}_{1}^{2} {t}_{1}^{3} + 4 {E}_{1}^{2} {t}_{1}^{2} {t}_{3} + 3 {E}_{1} {E}_{3} {t}_{1}^{2} {t}_{3} + 5 {E}_{1} {E}_{3} {t}_{3}^{2} + {E}_{3}^{2} {t}_{3}^{3}}{{E}_{1} {t}_{1} {t}_{3} \cdot ( {E}_{1} {t}_{1} + {E}_{3} {t}_{3} ) k} ) ,$$
$$k = 4 + 6 \cdot \frac{{t}_{1}}{{t}_{3}} + 4 \cdot {( \frac{{t}_{1}}{{t}_{3}} )}^{2} + \frac{{E}_{1}}{{E}_{3}} \cdot {( \frac{{t}_{1}}{{t}_{3}} )}^{3} + \frac{{E}_{1}}{{E}_{3}} \cdot \frac{{t}_{1}}{{t}_{3}} ,$$
where τᵣ is the interfacial shearing stress between the existing pipe and the mortar lining; the y′, R, Aₐ, and A_{b} are determined by the following equations:
$${y}^{′} = \frac{{E}_{1} {t}_{1}^{2} + 2 {E}_{1} {t}_{1} {t}_{3} + {E}_{3} {t}_{3}^{2}}{2 {E}_{1} {t}_{1} + 2 {E}_{3} {t}_{3}} , R = \frac{D}{2} + {y}^{′} - {t}_{1} - {t}_{3} , {A}_{a} = {t}_{1} \cdot b , {A}_{b} = {t}_{3} \cdot b$$
where b represents the unit length.

2. The method according to claim 1, wherein the determining whether the mortar lining wall thickness assumed value is taken as a mortar lining target wall thickness value according to a comparative result comprises:
if the comparative result is that the stress state parameter is consistent with the standard strength parameter, taking the mortar lining wall thickness assumed value as the mortar lining target wall thickness value; and
if the comparative result is that the stress state parameter is inconsistent with the standard strength parameter, re-determining the mortar lining wall thickness assumed value to re-determine the stress state parameter based on the re-determined mortar lining wall thickness assumed value.

3. The method according to claim 2, wherein the stress state parameter is consistent with the standard strength parameter, comprising:
the pipe top inner wall tensile stress is equal to a tensile strength of the mortar lining, the interfacial tensile stress between the existing pipe and the mortar lining is less than or equal to an interfacial tensile strength between the existing pipe and the mortar lining, and the interfacial shearing stress between the existing pipe and the mortar lining is less than or equal to an interfacial shearing strength between the existing pipe and the mortar lining;
wherein the tensile strength is the standard strength parameter corresponding to the tensile stress; the interfacial tensile strength is the standard strength parameter corresponding to the interfacial tensile stress; and the interfacial shearing strength is the standard strength parameter corresponding to the interfacial shearing stress.

4. The method according to claim 2, wherein the stress state parameter is inconsistent with the standard strength parameter, comprising:
the tensile stress of the pipe top inner wall is not equal to the tensile strength of the mortar lining;
the interfacial tensile stress is greater than the interfacial tensile strength between the existing pipe and the mortar lining; or
the interfacial shearing stress is greater than the interfacial shearing strength between the existing pipe and the mortar lining.

5. The method according to claim 1, further comprising:
detecting defects of the existing pipe to acquire defect data of appointed defect types,
wherein the appointed defect types comprise corrosion defects and/or crack defects.

6. The method according to claim 5, wherein if the appointed defect types are corrosion defects, the defect data comprises a corrosion defect quantity, a defect area of each of the corrosion defects, and a defect depth of each of the corrosion defects;
the determining a first equivalent elasticity modulus of an existing pipe in a current state and a second equivalent elasticity modulus of the existing pipe reaching a repaired design service life based on defect data of the existing pipe comprises:
determining a first mean volume loss rate of the existing pipe in the current state based on the attribute data of the existing pipe, the corrosion defect quantity, the defect area of each of the corrosion defects, and the defect depth of each of the corrosion defects;
obtaining the first equivalent elasticity modulus of the existing pipe in the current state according to the first mean volume loss rate;
obtaining a second mean volume loss rate of the existing pipe reaching the repaired design service life according to the first mean volume loss rate, a first pipe age of the existing pipe in the current state, and a second pipe age of the existing pipe reaching the repaired design service life; and
obtaining the second equivalent elasticity modulus of the existing pipe reaching the repaired design service life according to the second mean volume loss rate;
wherein the first mean volume loss rate f₁ is determined by the following equation:
$${f}_{1} = \frac{{\sum }_{i = 1}^{N} {S}_{i} \cdot {h}_{i}}{π \cdot ( D - 2 {t}_{0} ) \cdot {t}_{0} \cdot L} ,$$
where D is the pipe outer diameter of the existing pipe; t₀ is an initial wall thickness of the existing pipe; L is a length of a detected pipe section of the existing pipe; N is the corrosion defect quantity in the detected pipe section of the existing pipe; t₀ is the defect area of each of the corrosion defects; and hᵢ is the defect depth of each of the corrosion defects;
the first equivalent elasticity modulus E₁ of the existing pipe in the current state is obtained by the following equation according to the first mean volume loss rate f₁:
$${E}_{1} = ( 1 - 2 {v}_{0} ) \frac{12 {G}_{0} {K}_{0} ( 1 - {f}_{1} )}{4 {G}_{0} + 3 {G}_{0} {f}_{1}} ,$$
where v₀ is an initial Poisson's ratio of a tubular product pipe material of the existing pipe; G₀ is an initial shearing modulus of the tubular product pipe material; and K₀ is an initial volume modulus of the tubular product pipe material;
the second mean volume loss rate f₂ of the existing pipe reaching the repaired design service life by the following equation according to the first mean volume loss rate f₁, the first pipe age of the existing pipe in the current state, and the second pipe age of the existing pipe reaching the repaired design service life:
$${f}_{2} = {f}_{1} \cdot \frac{{Y}_{1} + {Y}_{2}}{{Y}_{1}} ,$$
where Y₁ is the first pipe age of the existing pipe in the current state, and Y₂ is the second pipe age of the existing pipe reaching the repaired design service life;
the second equivalent elasticity modulus E₂ of the existing pipe reaching the repaired design service life is obtained by the following equation according to the second mean volume loss rate f₂;
$${E}_{2} = ( 1 - 2 {v}_{0} ) \frac{12 {G}_{0} {K}_{0} ( 1 - {f}_{2} )}{4 {G}_{0} + 3 {G}_{0} {f}_{2}} ,$$
where v₀ is an initial Poisson's ratio of a tubular product pipe material of the existing pipe; G₀ is an initial shearing modulus of the tubular product pipe material; and K₀ is an initial volume modulus of the tubular product pipe material.

7. The method according to claim 6, wherein the determining a pipe top vertical deformation of the existing pipe reaching the repaired design service life based on a pipe top linear load on a unit length and the second equivalent elasticity modulus of the existing pipe comprises:
obtaining the first mean residual wall thickness of the existing pipe in the current state according to the first mean volume loss rate and the initial wall thickness of the existing pipe;
determining the first equivalent section inertia moment of the existing pipe in the current state according to the first mean residual wall thickness; obtaining a second mean residual wall thickness of the existing pipe reaching the repaired design service life
according to a second mean volume loss rate and the initial wall thickness of the existing pipe;
determining a second equivalent section inertia moment of the existing pipe in the current state according to the second mean residual wall thickness; and
determining the pipe top vertical deformation of the existing pipe reaching the repaired design service life according to the second equivalent elasticity modulus, the second equivalent section inertia moment, and the pipe top linear load;
wherein the first mean residual wall thickness of the existing pipe in the current state is t₁=f₁·t₀; f₁ is the first mean volume loss rate; and t₀ is the initial wall thickness of the existing pipe;
the first equivalent section inertia moment I₁ of the existing pipe in the current state is determined by the following equation according to the first mean volume loss rate t₁:
$${I}_{1} = \frac{π \cdot {D}^{4} \cdot ( 1 - {a}_{1}^{4} )}{64} , {a}_{1} = \frac{D - 2 {t}_{1}}{D}$$
where D represents a pipe outer diameter of the existing pipe;
the second mean residual wall thickness of the existing pipe in the current state is t₂=f₂·t₀; f₂ is the second mean volume loss rate; and t₀ is the initial wall thickness of the existing pipe;
the second equivalent section inertia moment f₂ of the existing pipe in the current state is determined by the following equation according to the second mean residual wall thickness t₂;
$${I}_{2} = \frac{π \cdot {D}^{4} \cdot ( 1 - {a}_{1}^{4} )}{64} , {a}_{2} = \frac{D - 2 {t}_{2}}{D} ,$$
where D represents the pipe outer diameter of the existing pipe;
the pipe top vertical deformation Δ of the existing pipe reaching the repaired design service life is determined by the following equation according to the second equivalent elasticity modulus E₂, the second equivalent section inertia moment I₂, and the pipe top linear load qₛₒᵢₗ;
$$Δ = \frac{{q}_{soil} {D}^{4}}{192 {E}_{2} {I}_{2}} ,$$
where D represents a pipe diameter of the existing pipe.

8. The method according to claim 5, wherein if the appointed defect types are crack defects, the defect data comprises a crack length, a crack depth, and a cracking angle;
the determining a first equivalent elasticity modulus of an existing pipe in a current state and a second equivalent elasticity modulus of the existing pipe reaching a repaired design service life based on defect data of the existing pipe comprises:
determining a splitting tensile strength of the existing pipe in the current state based on the crack length, the crack depth, the cracking angle, and initial splitting tensile strength data of the existing pipe;
determining the first equivalent elasticity modulus of the existing pipe in the current state according to the splitting tensile strength of the existing pipe in the current state; and
determining the second equivalent elasticity modulus of the existing pipe reaching the repaired design service life based on the first pipe age, the second pipe age, and the first equivalent elasticity modulus of the existing pipe;
where the splitting tensile strength data σ₁=σ₀·ρ₁·ρ₂ of the existing pipe in the current state; σ₀ is the initial splitting tensile strength data of the existing pipe; ρ₁ is an axial crack factor of the crack defect; and ρ₂ is a circular crack factor of the crack defect;
the first equivalent elasticity modulus of the existing pipe in the current state is
$${E}_{1} = \frac{9.15 \cdot {10}^{5} \cdot {σ}_{1}^{\frac{4}{3}}}{20.13 \cdot {σ}_{1}^{\frac{4}{3}} + 34.7} :$$
the second equivalent elasticity modulus of the existing pipe reaching the repaired design service life is
$${E}_{2} = \frac{{Y}_{1} + {Y}_{2}}{{Y}_{1}} \cdot {E}_{1} ;$$
where Y₂ is the first pipe age of the existing pipe in the current state, and Y₂ is the second pipe age of the existing pipe reaching the repaired design service life.

9. A pipe repairing method, comprising:
acquiring a mortar lining target wall thickness value when mortar is sprayed to repair an existing pipe, wherein the mortar lining target wall thickness value is determined by the mortar lining wall thickness design method according to claim 1; and
spraying mortar to repair the existing pipe according to the mortar lining target wall thickness value.

10. A mortar lining wall thickness design device, comprising:
a first determination unit, configured to determine a first equivalent elasticity modulus of an existing pipe in a current state and a second equivalent elasticity modulus of the existing pipe reaching a repaired design service life based on defect data of the existing pipe;
a second determination unit, configured to determine a pipe top vertical deformation of the existing pipe reaching the repaired design service life based on a pipe top linear load on a unit length and the second equivalent elasticity modulus of the existing pipe;
a third determination unit, configured to determine an equivalent additional load needed to be applied to the existing pipe reaching the pipe top vertical deformation in the current state according to the first equivalent elasticity modulus, the second equivalent elasticity modulus, and the pipe top linear load;
a fourth determination unit, configured to determine a stress state parameter of the existing pipe repaired according to a mortar lining wall thickness assumed value based on the equivalent additional load and the mortar lining wall thickness assumed value; and
a determining unit, configured to compare the stress state parameter with a standard strength parameter, and to determine whether the mortar lining wall thickness assumed value is taken as a mortar lining target wall thickness value according to a comparative result;
wherein the fourth determination unit comprises a pipe top section internal force determination unit, configured to determine a pipe top section internal force of the repaired existing pipe under the action of the equivalent additional load based on the equivalent additional load; and a stress state parameter determination unit, configured to determine the stress state parameter of the existing pipe repaired according to the mortar lining wall thickness assumed value based on the mortar lining wall thickness assumed value and the pipe top section internal force;
the pipe top section internal force comprises a pipe top section bending moment and a pipe top section shearing force; the stress state parameter determination unit comprises: a first stress state parameter determination sub-unit, configured to determine a pipe top inner wall tensile stress of the mortar lining of the existing pipe repaired according to the mortar lining wall thickness assumed value based on the mortar lining wall thickness assumed value, the pipe top section bending moment, and attribute data of the existing pipe; a second stress state parameter determination sub-unit, configured to determine an interfacial tensile stress between the existing pipe and the mortar lining of the existing pipe repaired according to the mortar lining wall thickness assumed value based on the mortar lining wall thickness assumed value, the pipe top section bending moment, and the attribute data of the existing pipe; and a third stress state parameter determination sub-unit, configured to determine an interfacial shearing stress between the existing pipe and the mortar lining of the existing pipe repaired according to the mortar lining wall thickness assumed value based on the mortar lining wall thickness assumed value, the pipe top section shearing force, and the attribute data of the existing pipe, wherein the pipe top inner wall tensile stress, the interfacial tensile stress, and the interfacial shearing stress all belong to the stress state parameters;
wherein the pipe top section bending moment is determined by the following equation:
$$M = \frac{1}{16} \cdot Δ {q}_{soil} {D}^{2} ,$$
where M represents the pipe top section bending moment, Δqₛₒᵢₗ represents the equivalent additional load, and D represents a pipe outer diameter of the existing pipe;
the pipe top section shearing force is determined by the following equation:
$${F}_{Q} = \frac{1}{2} \cdot Δ {q}_{soil} D ,$$
where F_{Q} is the pipe top section shearing force;
if an equivalent section inertia moment of the existing pipe in a service process does not change, the equivalent additional load is determined by the following equation:
$$Δ {q}_{soil} = \frac{{E}_{1}}{{E}_{2}} \cdot {q}_{soil} ,$$
Δqₛₒᵢₗ is the equivalent additional load, E₁ is the first equivalent elasticity modulus, E₂ is the second equivalent elasticity modulus, and qₛₒᵢₗ is the pipe top linear load;
if the equivalent section inertia moment of the existing pipe in the service process changes with increase of a service life, a first equivalent flexural rigidity of the existing pipe in the current state is determined in combination with a first equivalent section inertia moment and the first equivalent elasticity modulus of the existing pipe in the current state; a second equivalent flexural rigidity of the existing pipe reaching the repaired design service life is determined in combination with a second equivalent section inertia moment of the existing pipe reaching the repaired design service life and the second equivalent elasticity modulus; the equivalent additional load is determined by the following equation:
$$Δ {q}_{soil} = \frac{{E}_{1} {I}_{1}}{{E}_{2} {I}_{2}} \cdot {q}_{soil} ,$$
Δqₛₒᵢₗ is the equivalent additional load, E₁ is the first equivalent elasticity modulus, I₁ is the first equivalent section inertia moment, E₂ is the second equivalent elasticity modulus, I₂ is the second equivalent section inertia moment, and qₛₒᵢₗ is the pipe top linear load;
the pipe top inner wall tensile stress is determined by the following equations:
$${σ}_{s} = \frac{M {E}_{3}}{{E}_{1} {J}_{a} + {E}_{3} {J}_{b}} \cdot \frac{{Ry}^{′}}{R - {y}^{′}} - \frac{M {E}_{3}}{( {E}_{1} {A}_{a} + {E}_{3} {A}_{b} ) \cdot R} ,$$
$${J}_{a} = {R}^{3} b \cdot ln ( 1 + \frac{2 {t}_{1} ( 1 + βη )}{2 R - {t}_{1} + ( 2 R + {t}_{3} ) \cdot β η} ) + {Rbt}_{1} \cdot ( \frac{β η ( {t}_{1} + {t}_{3} )}{2 + 2 β η} - R ) ,$$
$${J}_{b} = {R}^{3} b \cdot ln ( 1 + \frac{2 {t}_{3} ( 1 + β η )}{2 R - {t}_{1} + ( 2 R - {t}_{3} ) \cdot β η - 2 {t}_{3}} ) - R b {t}_{3} \cdot ( \frac{1 + β}{2 + 2 β η} + {t}_{1} + R ) ,$$
$$β = \frac{{t}_{3}}{{t}_{1}} , η = \frac{{E}_{3}}{{E}_{1}} ,$$
where σₛ is the pipe top inner wall tensile stress, and R is a radius of an equivalent neutral axis of the repaired existing pipe; y′ is a distance between the equivalent neutral axis of the repaired existing pipe and the inner wall of the mortar lining; E₁ is the first equivalent elasticity modulus; E₃ is the elasticity modulus of the mortar lining; t₁ is a first mean residual wall thickness of the existing pipe in the current state; t₃ is the mortar lining wall thickness assumed value; Aₐ is a sectional area of the existing pipe within a unit length; and A_{b} is a sectional area of the mortar lining with the unit length;
the interfacial tensile stress between the existing pipe and the mortar lining is determined by the following equations:
$${σ}_{r} = ( \frac{{MF}_{3}}{{E}_{1} {J}_{a} + {E}_{3} {J}_{b}} \cdot {K}_{b} - \frac{{ME}_{3}}{( {E}_{1} {A}_{a} + {E}_{3} {A}_{b} ) \cdot R} \cdot {A}_{b} ) \cdot \frac{1}{b \cdot ( R + {t}_{3} - {y}^{′} )} ,$$
$${K}_{b} = {R}^{2} b \cdot ln ( 1 + \frac{2 {t}_{3} ( 1 + β η )}{( 2 R - {t}_{3} ) \cdot ( 1 + βη ) - ( {t}_{1} + {t}_{3} )} ) - {Rbt}_{3} ,$$
where σᵣ is the interfacial tensile stress between the existing pipe and the mortar lining;
the interfacial shearing stress between the existing pipe and the mortar lining is determined by the following equations:
$${τ}_{r} = \frac{{RF}_{Q}}{b \cdot ( R + {t}_{3} - {y}^{′} )} \cdot ( \frac{{E}_{3} {K}_{b}}{{E}_{1} {J}_{a} + {E}_{3} {J}_{b}} - \frac{1}{R} \cdot \frac{3 {E}_{1}^{2} {t}_{1}^{3} + 4 {E}_{1}^{2} {t}_{1}^{2} {t}_{3} + 3 {E}_{1} {E}_{3} {t}_{1}^{2} {t}_{3} + 5 {E}_{1} {E}_{3} {t}_{1} {t}_{3}^{2} + {E}_{3}^{2} {t}_{3}^{3}}{{E}_{1} {t}_{1} {t}_{3} \cdot ( {E}_{1} {t}_{1} + {E}_{3} {t}_{3} ) k} ) ,$$
$$k = 4 + 6 \cdot \frac{{t}_{1}}{{t}_{3}} + 4 \cdot {( \frac{{t}_{1}}{{t}_{3}} )}^{2} + \frac{{E}_{1}}{{E}_{3}} \cdot {( \frac{{t}_{1}}{{t}_{3}} )}^{3} + \frac{{E}_{1}}{{E}_{3}} \cdot \frac{{t}_{1}}{{t}_{3}} ,$$
where τᵣ is the interfacial shearing stress between the existing pipe and the mortar lining;
$${y}^{′} = \frac{{E}_{1} {t}_{1}^{2} + 2 {E}_{1} {t}_{1} {t}_{3} + {E}_{3} {t}_{3}^{2}}{2 {E}_{1} {t}_{1} + 2 {E}_{3} {t}_{3}} ,$$
where the y′, R, Aₐ, and A_{b} are determined by the following equation:
$${y}^{′} = \frac{{E}_{1} {t}_{1}^{2} + 2 {E}_{1} {t}_{1} {t}_{3} + {E}_{3} {t}_{3}^{2}}{2 {E}_{1} {t}_{1} + 2 {E}_{3} {t}_{3}} ,$$
$$R = \frac{D}{2} + {y}^{′} - {t}_{1} - {t}_{3} , {A}_{a} = {t}_{1} \cdot b , {A}_{b} = {t}_{3} \cdot b$$
where b represents the unit length.

11-13. (canceled)
